(19) United States
(12) Patent Application Publication
(10) Pub. No.: US 2026/0166776 A1
(43) Pub. Date: Jun. 18, 2026

(54) Mobile Batch Plant

(71) Applicant: RufDiamond Ltd., Coniston (CA)

(72) Inventor: Daryl Adams, Coniston (CA)

(21) Appl. No.: 19/423,226

(22) Filed: Dec. 17, 2025

(30) Foreign Application Priority Data
Dec. 18, 2024 (CA) 3259951

(51) Int. Cl. B28C 7/04; B05B 12/12; B28C 5/14; B28C 7/00; B28C 7/12; B28C 7/16

(52) U.S. Cl. CPC B28C 7/0486; B05B 12/124; B28C 5/142; B28C 7/0007; B28C 7/0076; B28C 7/0418; B28C 7/126; B28C 7/168

(57) ABSTRACT

A mobile batch plant comprises a vehicle chassis, a powerplant supported by the vehicle chassis, a hopper for storing a premix that is a preblended mixture of aggregate material and cement, a water tank for storing water, a water replenishment hose connectable to the water tank for replenishing the water in the water tank, a mix auger for mixing the premix and water to form shotcrete or concrete and a swivel chute connected to the mix auger to deliver the shotcrete or concrete.

### RELATED APPLICATION DATA

This application claims priority benefit to Canadian patent application ser. no. 3,259,951, filed Dec. 18, 2024, currently pending, the disclosure of which is incorporated by reference herein.

### TECHNICAL FIELD

The present invention relates generally to batch plants for producing shotcrete or concrete and, more particularly, to mobile batch plants, or vehicle-mounted batch plants, that transport all ingredients needed to produce the shotcrete or concrete.

### BACKGROUND

A mobile batch plant is a vehicle that transports a batch plant, or batching plant, as well as the required ingredients needed to produce shotcrete or concrete in the batch plant. Although some mobile batch plants are known in the art, these prior-art mobile batch plants are unsuited for challenging environments like underground mines or remote locations. In underground mines, where space is very limited, prior-art mobile batch plants are unsuitable. Likewise, prior-art mobile batch plants are unsuitable for remote locations where the vehicle must traverse different terrain.

An improved mobile batch plant is thus highly desirable.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

One aspect of the present disclosure is a mobile batch plant for making shotcrete or concrete. The mobile batch plant comprises a vehicle chassis, a powerplant supported by the vehicle chassis, a hopper for storing a premix that is a preblended mixture of aggregate material and cement, a water tank for storing water, a water replenishment hose connectable to the water tank for replenishing the water in the water tank, a mix auger for mixing the premix and water to form shotcrete or concrete and a swivel chute connected to the mix auger to deliver the shotcrete or concrete.

Another aspect of the present disclosure is a mobile batch plant comprising a vehicle chassis, a powerplant supported by the vehicle chassis, a hopper for storing a premix that is a preblended mixture of aggregate material and cement, a water tank for storing water, a mix auger for mixing the premix and water to form shotcrete, a mix controller for controlling proportions of the premix and water supplied to the mix auger based on ambient temperature and humidity, a swivel chute connected to the mix auger to deliver the shotcrete, a shotcrete sprayer and a shotcrete sprayer controller configured to control the shotcrete sprayer and a camera for capturing imagery of a surface on which shotcrete is to be sprayed, wherein the shotcrete sprayer controller is further configured to adjust motion of the shotcrete sprayer based on the imagery.

### BRIEF DESCRIPTION OF THE DRAWINGS

These and other features of the disclosure will become more apparent from the description in which reference is made to the following appended drawings.

FIG. 1 is a side view of a mobile batch plant in accordance with an embodiment of the present invention.

FIG. 2A is a front view of the mobile batch plant of FIG. 1.

FIG. 2B is a rear view of the mobile batch plant of FIG. 1.

FIG. 3 is a top view of the mobile batch plant of FIG. 1.

FIG. 4 is a side view of the mobile batch plant of FIG. 1 showing a water replenishment hose.

FIG. 5 is a schematic view of a water tank of the mobile batch plant as well as a filter, pump and sensor in accordance with one embodiment of the present invention.

FIG. 6 schematically depicts various optional modules that may be included in the mobile batch plant in accordance with other embodiments.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their full scope of equivalents.

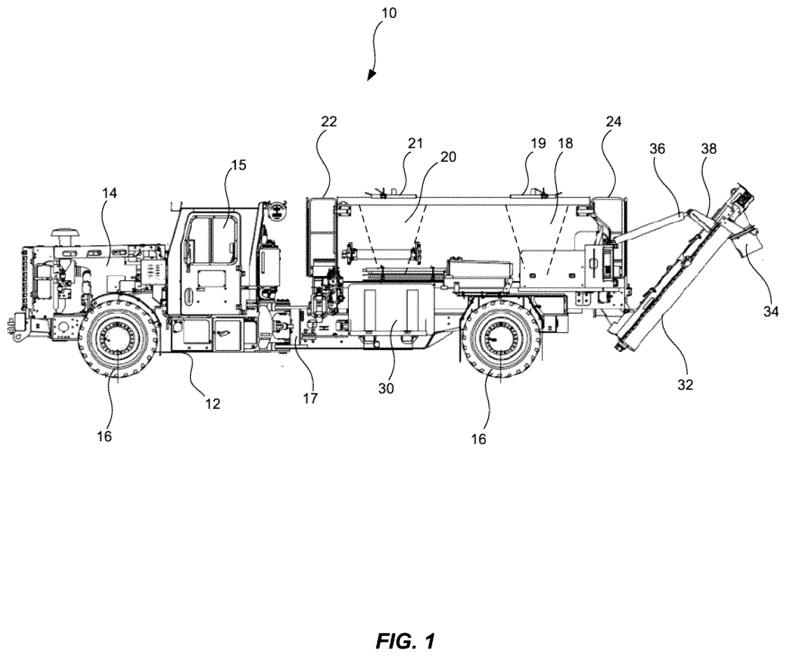

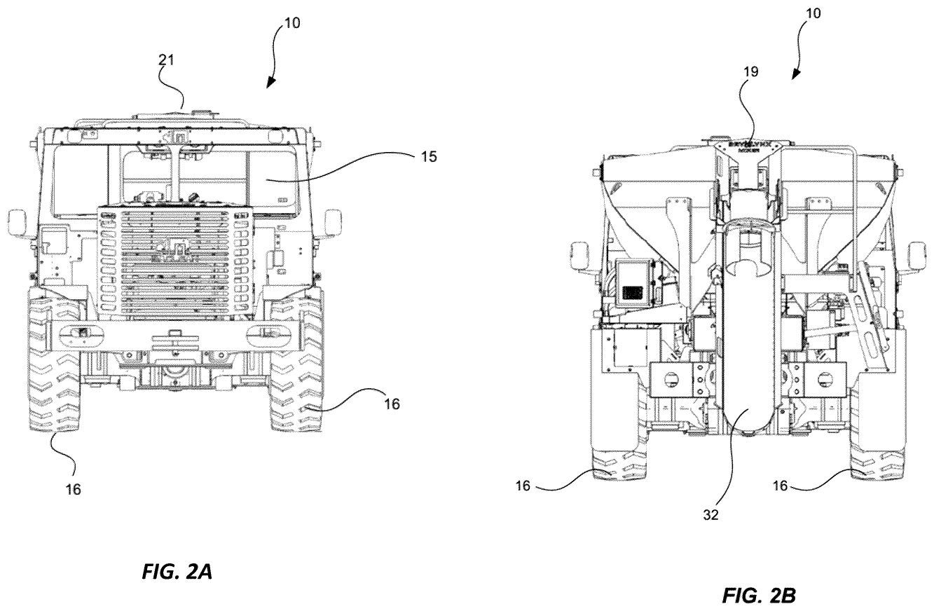

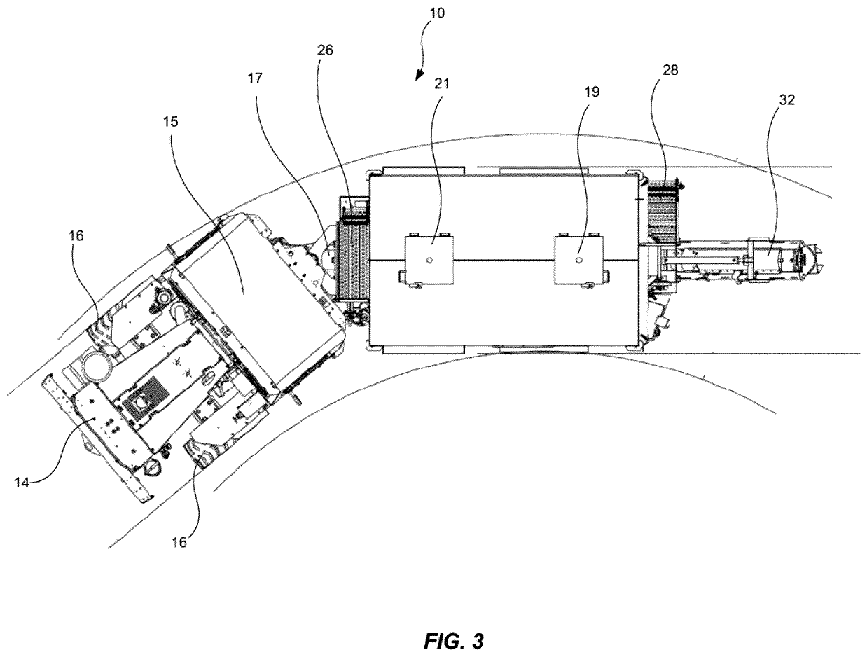

FIG. 1 is a side view of mobile batch plant in accordance with an embodiment of the present invention. FIGS. 2A and 2B are front and rear view of the mobile batch plant of FIG. 1. The mobile batch plant, which is generally denoted by reference numeral 10, includes a vehicle chassis 12 and a powerplant 14 supported by the vehicle chassis. The powerplant 14 may be an internal combustion engine, like a gasoline engine or diesel engine. The powerplant may alternatively be an electric motor or a hybrid electric powerplant. The mobile batch plant 10 may be a wheeled vehicle having a plurality of wheels 16 rotationally mounted to the chassis. Alternatively, the mobile batch plant 10 may be a tracked vehicle having two endless tracks mounted to the chassis. The chassis 12 of the mobile batch plant 10 may optionally be an articulated chassis as shown in FIG. 1 and further illustrated in FIG. 3. The articulated chassis enables the mobile batch plant to have a smaller turning radius than an equivalently sized non-articulated vehicle as shown in FIG. 3. A tight turning radius is particularly useful in underground mines where the mobile batch plant may need to navigate through sharp turns or corners to access various places in the mine. The front chassis and rear chassis may be connected via a pivot mechanism 17 (or other rotational joint or articulation mechanism to permit articulation of the mobile batch plant). The articulated chassis may comprise a forward chassis supporting the powerplant 14 and a vehicle cab 15. The articulated chassis may also comprise a rear chassis supporting a batch plant and the ingredients to produce the shotcrete as will be explained in greater detail below.

In the embodiment shown in FIGS. 1, 2A, 2B and 3, the mobile batch plant 10 includes a hopper 18 for storing a premix (or preblended mixture of aggregate material and cement). At the top of the hopper 18 is a hopper access lid 19 for loading premix (i.e. the preblended mixture) into the hopper 18. The lid 19 may be a watertight hatch to prevent ingress of water into the hopper. The hopper 18 is thus a dry hopper. Optionally, the mobile batch plant has a front ladder 22 and a rear ladder 24 which may be used to access the lid to open and close the lid. As shown in FIG. 3, the mobile batch plant may have a front platform 26 to provide easy access to the front ladder 22. Likewise, as shown in FIG. 3, the mobile batch plant 10 may have a rear platform 28 to provide easy access to the rear ladder 24. In the embodiment shown in FIGS. 1, 2A, 2B and 3, the mobile batch plant 10 includes a water tank 30 for storing water. In a variant, there may be two water tanks, one on each side of the vehicle. In a further variant, there may be three or more water tanks. In the illustrated embodiment, the mobile batch plant 10 includes a mix auger 32 for mixing the premix (i.e. the preblended mixture containing aggregate material and cement) and water to form shotcrete or concrete. In a variant, the mobile batch plant has a mixing bowl for initially mixing the premix and water before being further mixed by the mix auger. The mobile batch plant may have a conveyor disposed beneath the hoppers to transport premix into the mix auger or into the mixing bowl. As such, the mobile batch plant creates shotcrete using a wet mix process. The shotcrete may be composed of water and a premix in a predetermined proportion. The premix (preblended mixture) includes cement or other cementitious materials and aggregate material such as fine and/or coarse aggregates (e.g. sand or gravel), additives (e.g. pigments) and admixtures (e.g. accelerators, plasticizers, hardeners) and may also include strengthening fibres. In one embodiment, the mobile batch plant 10 includes an optional second hopper 20 and a second lid 21 for a second supply of premix.

The mobile batch plant 10 may optionally include a swivel chute 34 connected to the mix auger 32 to deliver the shotcrete or concrete as illustrated in FIG. 1. The mobile batch plant 10 may include an auger deployment actuator 36 that is pivotally connected to a rear portion of the mobile batch plant 10 and pivotally connected to a bracket 38 affixed to the mix auger 32. Extension of the auger deployment actuator 36 causes the mix auger to be deployed into an operational posture. Retraction of the auger deployment actuator 36 causes the mix auger to be folded upwardly into a stowed posture (or transport posture).

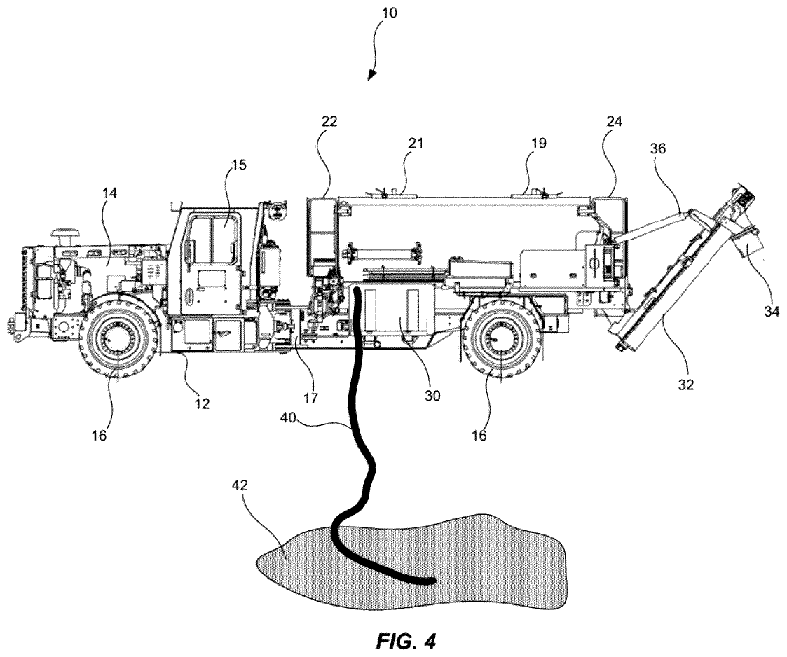

In the embodiment shown in FIG. 4, the mobile batch plant 10 includes a water replenishment hose 40 connectable to the water tank 30 for replenishing the water in the water tank. For example, in operation, the mobile batch plant may deplete its supply of water by drawing all of the water from the water tank for mixing with the premix to form the shotcrete. Instead of requiring the mobile batch plant to drive back to a resupply area to be resupplied with water, the mobile batch plant 10 may deploy the water replenishment hose 40 to draw new water from a nearby external source of water 42 such as a pond, river, lake, pool, external water supply tank, etc.

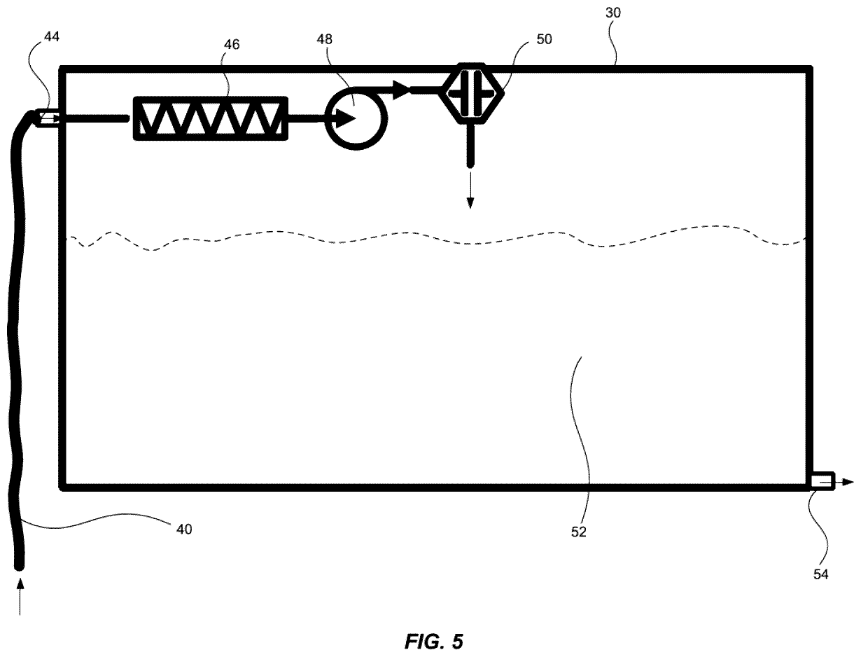

In the embodiment shown in FIG. 5, the mobile batch plant 10 includes an optional water inlet connector 44 for connecting the water replenishment hose 40 to the water tank 30. In the embodiment of FIG. 5, the mobile batch plant 10 optionally includes a water filter 46 for filtering the water entering the water tank 30. In the embodiment shown in FIG. 5, the mobile batch plant includes water pump 48 for drawing (pumping) water into the water tank 30. The water pump 48 may be integrated into the water tank 30 or it may be separate from the water tank 30. In the embodiment depicted in FIG. 5, the mobile batch plant 10 optionally includes a water sensor 50 for sensing water purity of the water entering the water tank 30. The water filter 46 may be upstream of the water pump 48 as shown in FIG. 5 or it may alternatively be downstream of the water pump 48. Similarly, the water sensor 50 may be downstream of the water pump as shown or it may be upstream of the water pump. In the embodiment illustrated in FIG. 5, water is drawn from the external water source via the water replenishment hose 40, enter the water tank 30 via the water inlet connector 44, is filtered by the water filter 46, is drawn through the water pump 48, is sensed by the water sensor 50, and is accumulated in the water tank 30 as a replenished supply of water 52 to be drawn from the water tank 30 via water outlet 54 for mixing with the premix. In one variant, the water tank may include a valve to divert water to a drain in a case where the water sensor senses that the water, even after filtration by the water filter, is too impure to use in making shotcrete.

For operating in cold environments, the mobile batch plant may optionally include heated water lines to deliver the water from the water tank 30 to the mix auger 32. Optionally, the water tank may be heated as well.

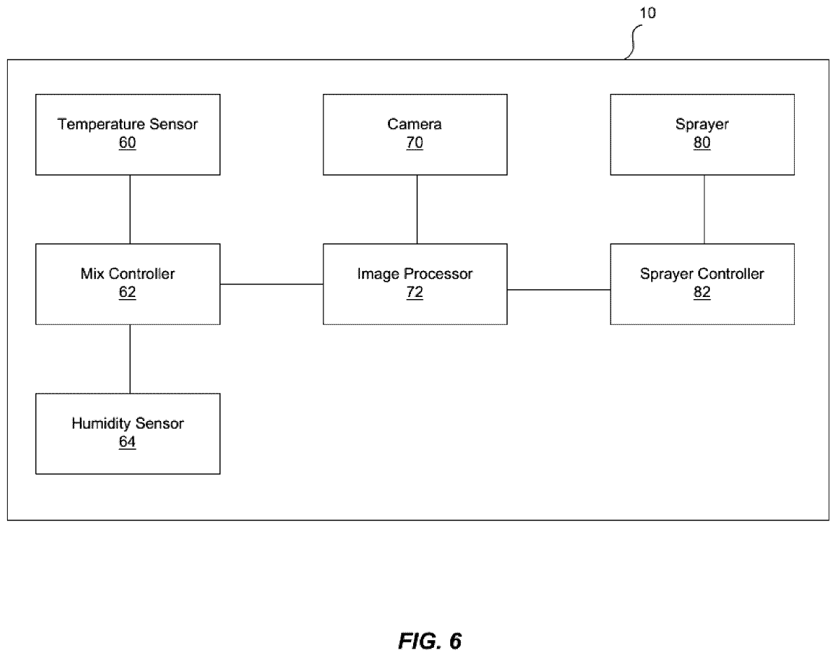

In one optional implementation, as depicted in FIG. 6, the mobile batch plant 10 may have a temperature sensor 60 to sense an ambient temperature of the air at a work site where the shotcrete is to be sprayed. In a variant, the temperature sensor is a remote temperature sensor like a thermal imager or infrared sensor that remotely senses a surface temperature of the surface to be sprayed. The mobile batch plant 10 may have a mix controller 62 to control proportions of water and premix based on the ambient temperature or surface temperature. The mobile batch plant 10 may optionally also have a humidity sensor 64 to sense an ambient humidity of the air at the work site. The mix controller 62 may be configured to control the proportions of water and premix based on the ambient humidity. Optionally, the mix controller 62 may control the proportions of water and premix based on both the ambient temperature and the ambient humidity. Optionally, the mix controller 62 may be configured to control a heater that heats the heated water lines. In another optional implementation, the mix controller 62 may be configured to control the dose or quantity of accelerator/hardener, plasticizer, fibres, or other admixture or additive that is being added to the mixing bowl or mix auger.

In one optional implementation, the mobile batch plant 10 has a camera 70 for capturing imagery of a surface to be sprayed with shotcrete. The mobile batch plant 10 may include an image processor 72 to identify surface characteristics of the surface, e.g. mine tunnel, and to determine a shotcrete mixture based on the surface characteristics of the surface. The surface characteristics may be defined by a type of material or substance that constitutes the surface (e.g. rock face, wood, a pre-existing layer of concrete or shotcrete, etc.). The surface characteristics may be defined by the granularity or roughness of the surface (smooth, rough, pocked) and may include any reinforcement materials such as wire mesh, rebar, protruding rock bolts, etc. that is attached to or otherwise disposed on the surface. The image processor 72 can determine the optimized shotcrete mixture and send a signal to the mix controller to mix the shotcrete mixture to best suit the surface characteristics of the surface. As shotcrete is applied, the camera and image processor may detect the surface characteristics of the applied shotcrete and then adjust the mixture accordingly.

In one optional implementation, the mobile batch plant may include a shotcrete sprayer 80 mounted to the mobile batch plant or towed by the mobile batch plant. In this optional implementation, the swivel chute may be replaced with a fixed chute that delivers the shotcrete into a container which feeds the shotcrete sprayer. The shotcrete sprayer 80 may have a pneumatic sprayer pump and sprayer nozzle for pneumatically spraying the shotcrete onto a surface. The sprayer may include a multi-axis motorized mechanism to orient the nozzle at a range of angles for spraying shotcrete onto surfaces that are at various angles. The mobile batch plant may optionally include a shotcrete sprayer controller 82 configured to control the shotcrete sprayer by providing control signals to the multi-axis motorized mechanism. The sprayer controller 82 may receive user input from a user to direct the nozzle at a desired surface to be sprayed. Alternatively, the mobile batch plant may include the camera, as noted above, or multiple cameras, for capturing imagery of a surface or multiple surfaces to be sprayed. The sprayer controller 82 may be further configured to adjust motion of the shotcrete nozzle based on the imagery from the one or more cameras. Accordingly, in one implementation, the sprayer controller may automatically spray the shotcrete onto one or more surfaces by capturing the camera imagery using the one or more cameras to determine where to spray the shotcrete and then controlling the multi-axis motorized mechanism to direct the nozzle toward the one or more surfaces to be sprayed. Optionally, the sprayer controller may detect a distance to a surface to be sprayed and automatically adjusts a pneumatic pressure of the sprayer to optimize the application of the shotcrete based on the distance from the nozzle to the surface and also optionally based on the mixture. Optionally, the sprayer controller may signal the mix controller to automatically adjust the mixture of the shotcrete and/or adjust the pressure of the sprayer based on the distance to the surface. The sprayer controller may optionally send a signal to the mix controller of the mobile batch plant to adjust the delivery rate of the shotcrete by adjusting the delivery rates of the premix and water. The mix controller and sprayer controller may implemented in hardware or software or a combination thereof.

Any method steps or modules disclosed herein may be implemented as software, i.e. as coded instructions stored on a computer readable medium which performs the foregoing steps when the computer readable medium is loaded into memory and executed by the microprocessor of the computing device. A computer readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc.

For the purposes of this specification, the expression “module” is used expansively to mean any software, hardware, firmware, or combination thereof that performs a particular task, operation, function or a plurality of related tasks, operations or functions. When used in the context of software, the module may be a complete (standalone) piece of software, a software component, or a part of software having one or more routines or a subset of code that performs a discrete task, operation or function or a plurality or related tasks, operations or functions. Software modules have program code (machine-readable code) that may be stored in one or more memories on one or more discrete computing devices. The software modules may be executed by the same processor or by discrete processors of the same or different computing devices.

Computer readable program instructions can be downloaded to respective computing devices from a computer readable storage medium or to an external computer or external storage device via a data network, for example, the Internet, a local area network, a wide area network or a wireless network. The network may comprise copper transmission cables, optical transmission fibers, wireless transmission, routers, firewalls, switches, gateway computers and/or edge servers. A network adapter card or network interface controller (NIC) in each computing device receives computer readable program instructions from the network and transmits the computer readable program instructions for storage in a computer readable storage medium within the respective computing device.

Computer readable program instructions are computer-executable instructions in machine-readable code for carrying out operations of the present invention and may be assembler instructions, instruction-set-architecture (ISA) instructions, machine instructions, microcode, firmware instructions, state-setting data, configuration data for integrated circuitry, or either source code or object code written in any combination of one or more programming languages, including an object oriented programming language and procedural programming languages. The computer-executable instructions executed by a computing device carry out program processes such as routines, programs, objects, components, logic, data structures that perform particular tasks or implement particular abstract data types.

Various aspects of the invention are described with reference to flowcharts and/or block diagrams of methods, systems, and computer program products. Each block of the flowcharts and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified by a block of the flowchart and/or block diagram.

The computer readable program instructions may also be loaded onto a computer, other programmable data processing apparatus, or other device to cause a series of operational steps to be performed on the computer, other programmable apparatus or other device to produce a computer implemented process or computer-implemented method, such that the instructions which execute on the computer, other programmable apparatus, or other device implement the functions/acts specified in the flowchart and/or block diagram.

The flowchart and block diagrams in the figures illustrate the architecture, functionality, and operation of possible implementations of systems, methods, and computer program products according to various embodiments of the present invention. Each block in the flowchart or block diagrams may represent a module, segment, or portion of instructions, which comprises one or more executable instructions for implementing the specified function. In some alternative implementations, the functions noted in the blocks may occur out of the order shown in the Figures. For example, two blocks shown in succession may be executed substantially concurrently, or the blocks may sometimes be executed in the reverse order, depending upon the functionality involved. Each block of the block diagrams and/or flowcharts, and combinations of these blocks, can be implemented by special purpose hardware-based systems that perform the specified functions or acts or carry out combinations of special purpose hardware and computer instructions.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. A mobile batch plant comprising:
a vehicle chassis;
a powerplant supported by the vehicle chassis;
a hopper for storing a premix that is a preblended mixture of aggregate material and cement;
a water tank for storing water;
a water replenishment hose connectable to the water tank for replenishing the water in the water tank;
a mix auger for mixing the premix and water to form shotcrete or concrete; and
a swivel chute connected to the mix auger to deliver the shotcrete or concrete.

2. The mobile batch plant of claim 1 comprising a water pump for drawing water into the water tank.

3. The mobile batch plant of claim 2 comprising a water filter for filtering the water entering the water tank.

4. The mobile batch plant of claim 3 comprising a water sensor for sensing water purity of the water entering the water tank.

5. The mobile batch plant of claim 1 comprising heated water lines to deliver the water from the water tank to the mix auger.

6. The mobile batch plant of claim 1 comprising wheels rotationally mounted to the vehicle chassis.

7. The mobile batch plant of claim 1 comprising tracks mounted to the vehicle chassis.

8. The mobile batch plant of claim 5 wherein the vehicle chassis is an articulated chassis comprising a forward chassis supporting the powerplant and a vehicle cab, wherein the articulated chassis also comprises a rear chassis supporting the hopper, the water tank, the mix auger and the swivel chute.

9. The mobile batch plant of claim 1 comprising a shotcrete sprayer.

10. The mobile batch plant of claim 9 comprising a shotcrete sprayer controller configured to control the shotcrete sprayer and a camera for capturing imagery of a surface on which shotcrete is to be sprayed, wherein the shotcrete sprayer controller is further configured to adjust motion of the shotcrete sprayer based on the imagery.

11. A mobile batch plant comprising:
a vehicle chassis;
a powerplant supported by the vehicle chassis;
a hopper for storing a premix that is a preblended mixture of aggregate material and cement;
a water tank for storing water;
a mix auger for mixing the premix and water to form shotcrete;
a mix controller for controlling proportions of the premix and water supplied to the mix auger based on ambient temperature and humidity;
a swivel chute connected to the mix auger to deliver the shotcrete;
a shotcrete sprayer; and
a shotcrete sprayer controller configured to control the shotcrete sprayer and a camera for capturing imagery of a surface on which shotcrete is to be sprayed, wherein the shotcrete sprayer controller is further configured to adjust motion of the shotcrete sprayer based on the imagery.

12. The mobile batch plant of claim 11 wherein the sprayer controller detects a distance to the surface to be sprayed and automatically adjusts a pressure of the sprayer to optimize the application of the shotcrete based on the distance from the nozzle to the surface.

13. The mobile batch plant of claim 12 wherein the sprayer controller sends a signal to the mix controller to automatically adjust the mixture based on the distance to the surface.

14. The mobile batch plant of claim 12 wherein the sprayer controller sends a signal to the mix controller to adjust delivery rates of the premix and water to adjust a delivery rate of the shotcrete sprayer.

15. The mobile batch plant of claim 11 comprising an image processor to identify surface characteristics of the surface and to determine a shotcrete mixture based on the surface characteristics of the surface.

16. The mobile batch plant of claim 15 wherein the image processor is configured to send a signal to the mix controller to mix the shotcrete mixture to best suit the surface characteristics of the surface.

17. The mobile batch plant of claim 11 comprising a water replenishment hose connectable to the water tank for replenishing the water in the water tank and a water pump for drawing the water into the water tank.

18. The mobile batch plant of claim 17 comprising a water filter for filtering the water entering the water tank.

19. The mobile batch plant of claim 18 comprising a water sensor for sensing water purity of the water entering the water tank.

20. The mobile batch plant of claim 19 comprising heated water lines to deliver the water from the water tank to the mix auger.
